(19) United States
(12) Patent Application Publication
(10) Pub. No.: US 2007/0267982 A1
(43) Pub. Date: Nov. 22, 2007

(54) Discharge lamp lighting apparatus

(76) Inventor: Koji Kito, Kamagaya (JP)

Correspondence Address: MCDERMOTT WILL & EMERY LLP, 600 13TH STREET, N.W., WASHINGTON, DC, 20005-3096, US

(21) Appl. No.: 11/707,269

(22) Filed: Feb. 16, 2007

(30) Foreign Application Priority Data
May 17, 2006 (JP) 2006-137205

(51) Int. Cl. H05B 41/14

(52) U.S. Cl. 315/291

(57) ABSTRACT

A discharge lamp lighting apparatus for lighting a discharge lamp includes a power control circuit for detecting a lamp voltage and a lamp current of the discharge lamp and controlling a lamp power, and an input voltage changeover circuit for changing over an input voltage to be input to the power control circuit according to the lamp voltage or a voltage corresponding to the lamp voltage. A discharge lamp lighting apparatus that is high in efficiency and less in unnecessary radiation even when the lamp voltage is low is provided.

### INCORPORATION BY REFERENCE

The present invention claims priority from Japanese application JP 2006-137205 filed on May 17, 2006, the content of which is hereby incorporated by reference into this application.

### BACKGROUND OF THE INVENTION

The present invention relates to a discharge lamp lighting apparatus for lighting a discharge lamp used in a projection display such as a liquid crystal projector.

As a light source for the projection display, a high pressure discharge lamp such as a metal-halide lamp or a high pressure mercury lamp is used for the reason that it is easy to obtain a light source that is high in conversion efficiency and that resembles a point source of light. For lighting the high pressure discharge lamp, a dedicated discharge lamp lighting apparatus for supplying a voltage and a current required for lighting is used.

For example, in the discharge lamp lighting apparatus disclosed in JP-A-10-3996, an output of lamp voltage detection means and/or lamp current detection means for a high pressure discharge lamp is input to control means via variable voltage division means, a lighting main circuit is controlled by the control means, and the variable voltage division means is operated to adjust light.

### SUMMARY OF THE INVENTION

In the conventional discharge lamp lighting apparatus, the input voltage is constant. When the lamp voltage is low, therefore, the on-duty of a switching transistor in a power control circuit decreases. This results in a problem of an increased switching loss, a lowered efficiency, and increased unnecessary radiation. In recent years, high-power lamps are demanded to raise the luminance of the projection display, and this has become an important problem.

By the way, the on-duty means the ratio of an on-period in one repetition period when switching between the on-state and the off-state is conducted periodically. Denoting one repetition period by T, the on-interval in one repetition period by Tₒₙ, and the off-interval by T_{off}(=T−Tₒₙ), the on-duty is represented by Tₒₙ/T.

The present invention has been made in order to solve the above-described problem. An object of the present invention is to provide a discharge lamp lighting apparatus that is high in efficiency and less in unnecessary radiation even when the lamp voltage is low.

In order to achieve the object, discharge lamp lighting apparatuses according to first to third aspects of the present invention described hereafter are provided.

A discharge lamp lighting apparatus according to a first aspect of the present invention includes a power control circuit for detecting a lamp voltage and a lamp current of the discharge lamp and controlling a lamp power, and an input voltage changeover circuit for changing over an input voltage to be input to the power control circuit on the basis of the lamp voltage or a voltage corresponding to the lamp voltage. In such a discharge lamp lighting apparatus, it is desirable that the input voltage changeover circuit lowers the input voltage as the lamp voltage or the voltage corresponding to the lamp voltage becomes lower.

A discharge lamp lighting apparatus according to a second aspect of the present invention includes a power control circuit. And the power control circuit includes an input voltage side to which a voltage is input and a ground side, and includes a switching transistor provided on the ground side. Furthermore, the power control circuit detects a lamp voltage and a lamp current of the discharge lamp and controls a lamp power.

A discharge lamp lighting apparatus according to a third aspect of the present invention includes a discharge lamp, a power control circuit for detecting a lamp voltage and a lamp current of the discharge lamp and controlling a lamp power, and an input voltage changeover circuit for changing over an input voltage to be input to the power control circuit according to the lamp voltage or a voltage corresponding to the lamp voltage.

Other objects, features and advantages of the invention will become apparent from the following description of the embodiments of the invention taken in conjunction with the accompanying drawings.

### BRIEF DESCRIPTION OF THE DRAWINGS

FIG. 1 is a first circuit diagram of a discharge lamp lighting apparatus according to an embodiment of the present invention;

FIG. 2 is a schematic configuration diagram of a projection display using a discharge lamp lighting apparatus according to the present invention;

FIGS. 3A and 3B are diagrams for explaining operation of a conventional discharge lamp lighting apparatus;

FIGS. 4A and 4B are diagrams for explaining operation of a conventional discharge lamp lighting apparatus;

FIG. 5 is a diagram for explaining operation of the discharge lamp lighting apparatus having the circuit shown in FIG. 1;

FIG. 6 is a second circuit diagram of a discharge lamp lighting apparatus according to an embodiment of the present invention; and

FIG. 7 is a diagram for explaining operation of the discharge lamp lighting apparatus having the circuit shown in FIG. 6.

### DESCRIPTION OF THE EMBODIMENTS

Hereafter, embodiments of a discharge lamp lighting apparatus according to the present invention will be described with reference to the drawings.

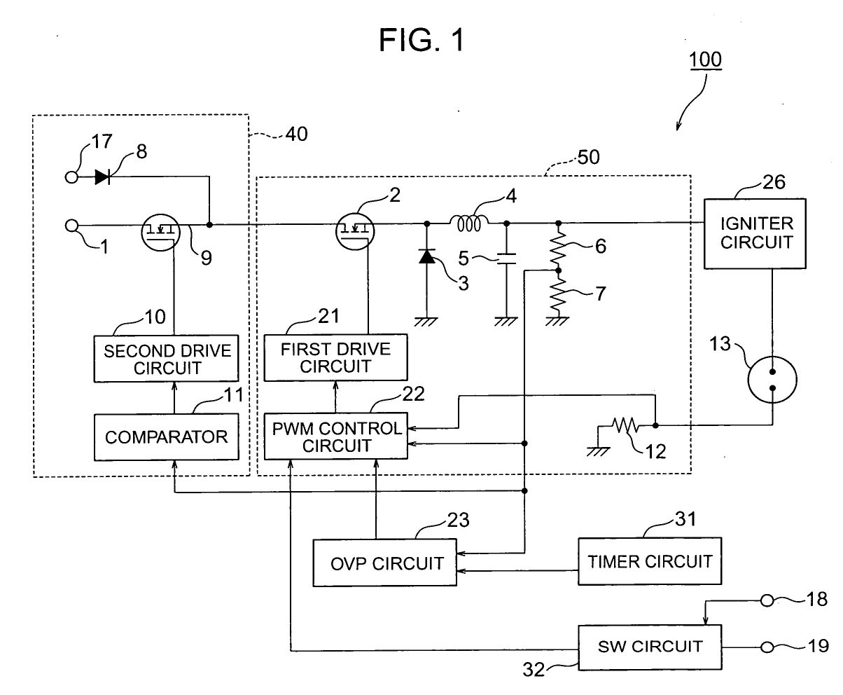

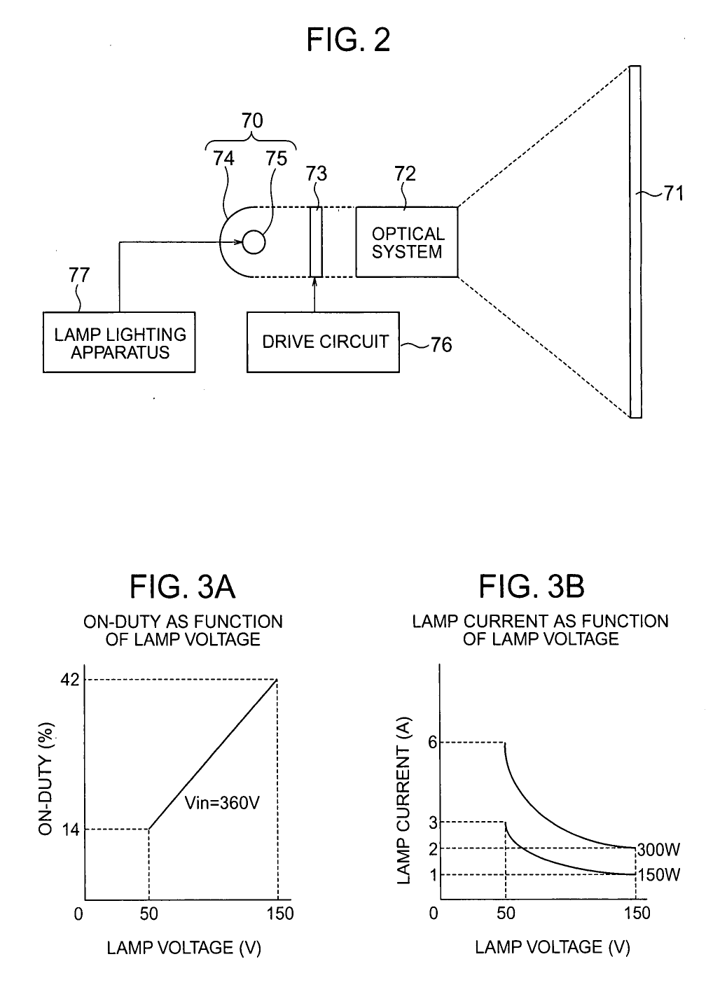

FIG. 1 schematically shows an example of a circuit diagram of a discharge lamp lighting apparatus 100 according to the present invention. FIG. 2 shows a schematic configuration diagram of a projection display apparatus using the discharge lamp lighting apparatus 100 according to the present invention. As shown in FIG. 2, the projection display apparatus includes a light source 70, an optical system 72, an image display device 73, a drive circuit 76, and a discharge lamp lighting apparatus 77.

As shown in FIG. 2, the light source 70 includes a reflector 74 and a high pressure discharge lamp 75. The light source 70 is disposed so as to irradiate the image display device 73 from its back with light. Light transmitted through the image display device 73 is projected onto a screen 71 by the optical system 72. The image display device 73 can be formed of, for example, a liquid crystal display. The drive circuit 76 in this case is an image display device drive circuit 76. The image display device 73 is driven by the drive circuit 76, and an image is displayed thereon. As a result, a large-screen image is obtained on the screen 71. The discharge lamp lighting apparatus 77 can conduct starting and lighting control of the high pressure discharge lamp 75. Here, a voltage applied to the high pressure discharge lamp 75 is called “lamp voltage,” and a current flowing to the high pressure discharge lamp 75 is called “lamp current.”

The discharge lamp lighting apparatus 100 according to the present invention includes an input voltage changeover circuit 40, a power control circuit 50, a lamp-on signal input terminal 18, a PWM control circuit power supply input terminal 19, an overvoltage protection circuit (OVP circuit) 23, an igniter circuit 26, a timer circuit 31, and a switch circuit (SW circuit) 32.

In the example shown in FIG. 1, the power control circuit 50 includes a MOSFET 2, a diode 3, a choke coil 4, a capacitor 5, resistors 6, 7 and 12, a first drive circuit 21, and a PWM control circuit 22. The power control circuit 50 controls an output voltage and an output current by using the PWM control circuit 22 on the basis of detection results of the lamp voltage and the lamp current. The igniter circuit 26 generates a high voltage pulse and starts a high pressure discharge lamp 13.

The overvoltage protection circuit (OVP circuit) 23 stops operation of the power control circuit 50 when an overvoltage has occurred. The timer circuit 31 outputs a signal that stops operation of the overvoltage protection circuit 23 at the time of start. The switch circuit (SW circuit) 32 controls supply of power to the PWM control circuit 22 on the basis of a lamp-on signal which is input to the terminal 18.

In the example shown in FIG. 1, the input voltage changeover circuit 40 includes a diode 8, a MOSFET 9, a second drive circuit 10, a comparator 11, and a second power supply input terminal 17. When the lamp voltage has become lower than a preset threshold, the input voltage changeover circuit 40 turns off the MOSFET 9, and changes an input voltage of the power control circuit 50 from a voltage at a first power supply input terminal 1 over to a voltage at the second power supply input terminal 17. In the present embodiment, the voltage applied to the first power supply input terminal 1 is set to be lower than the voltage applied to the first power supply input terminal 1. Specifically, a voltage of 360 V is applied to the first power supply input terminal 1, and a voltage of 180 V is applied to the second power supply input terminal 17. However, the voltages applied to the first power supply input terminal 1 and the second power supply input terminal 17 are not restricted to these voltage values.

The lamp voltage of the discharge lamp 13 or a voltage corresponding thereto is detected from a voltage obtained by voltage division using the resistors 6 and 7. The current flowing through the discharge lamp 13 is detected from a voltage generated across the resistor 12. Although the voltage and current of the discharge lamp are detected by using the resistors 6, 7 and 12 here, the present invention is not restricted to this.

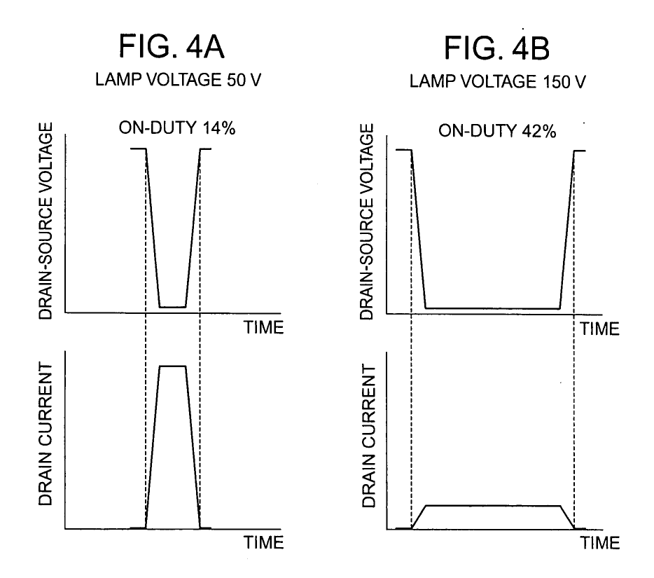

Operation of the conventional discharge lamp lighting apparatus will now be described with reference to FIGS. 3A, 3B, 4A and 4B.

FIG. 3A schematically shows a relation between the on-duty of the MOSFET and the lamp voltage obtained when an input voltage Vin of the power control circuit in the conventional discharge lamp lighting apparatus is 360 V. Since the lamp voltage rises according to the lamp life, the lamp voltage changes, for example, from 50 V to 150 V as shown in FIG. 3A. Although the on-duty is 42% (150/360 V) when the lamp voltage is 150 V, the on-duty decreases to 14% (50/360 V) when the lamp voltage is 50 V.

FIG. 3B schematically shows a relation between the lamp current and the lamp voltage with respect to lamps of two kinds: a 150-W lamp and a 300-W lamp. Because of constant-power control which makes the brightness constant, the lamp current is in inverse proportion to the lamp voltage. In the 300-W lamp, a current which is twice that in the 150-W lamp is needed.

FIG. 4A schematically shows a drain-source voltage and a drain current of the MOSFET when the lamp voltage is 50 V. FIG. 4B schematically shows the drain-source voltage and the drain current of the MOSFET when the lamp voltage is 150 V.

As appreciated from FIG. 4A and FIG. 4B, the on-duty becomes one third when the lamp voltage is 50 V as compared with when the lamp voltage is 150 V. In addition, the lamp current becomes three times. As a result, the drain current becomes approximately nine times. Accordingly, the switching loss remarkably increases, resulting in a lowered efficiency. Furthermore, unnecessary radiation also increases because of the increase of the drain current. This poses a problem especially for the 300-W lamp through which a large current flows.

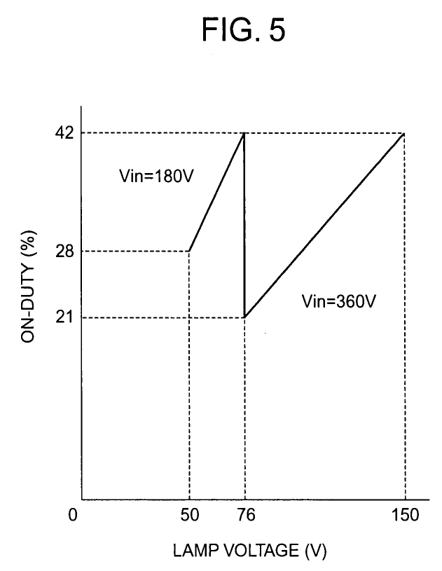

Operation of the discharge lamp lighting apparatus according to the present invention shown in FIG. 1 will now be described. FIG. 5 shows a relation between the on-duty and the lamp voltage of the MOSFET 2 in the power control circuit included in the discharge lamp according to the present invention shown in FIG. 1.

The lamp voltage detected by using the resistors 6 and 7 is input to the comparator 11. When the lamp voltage is at least 76 V, the comparator 11 outputs a signal to the second drive circuit 10 to turn on the MOSFET 9. When the lamp voltage is lower than 76 V, the comparator 11 outputs a signal to the second drive circuit 10 to turn off the MOSFET 9. The drain voltage of the MOSFET 2 is switched to become 360 V applied to the first power supply input terminal when the lamp voltage is at least 76 V, and become 180 V applied to the second power supply input terminal when the lamp voltage is lower than 76 V. As a result, the on-duty at the time when the lamp voltage is 50 V increases to 28% (50 V/180 V) which is twice. Accordingly, the drain current of the MOSFET decreases and the loss decreases. Thus, it is possible to provide a discharge lamp lighting apparatus that is high in efficiency and less in unnecessary radiation.

Although the threshold for the input lamp voltage of the comparator 11 is set equal to 76 V here, the threshold is not restricted to this value, but may be set to an arbitrary value in the present invention.

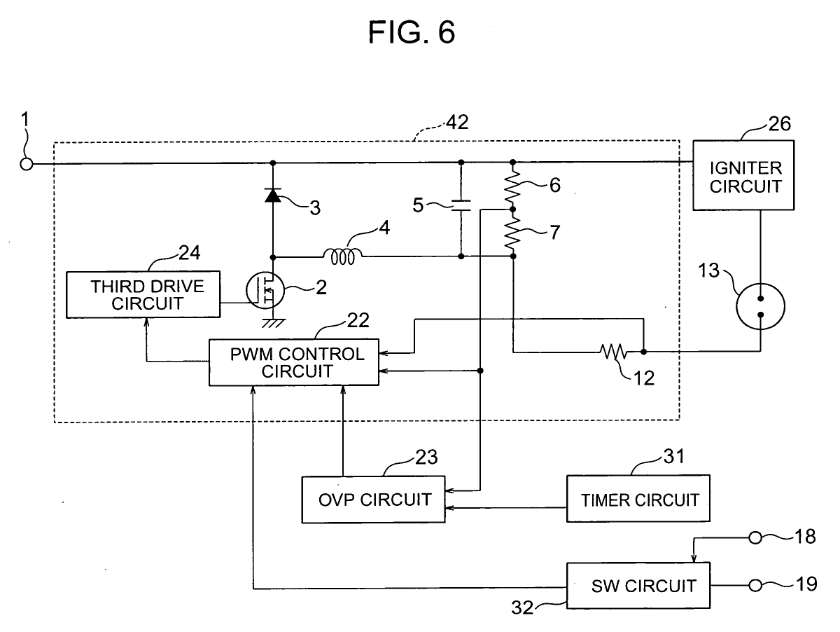

FIG. 6 is an example of a circuit diagram of another embodiment of a discharge lamp lighting apparatus according to the present invention. In FIG. 6, reference numeral 24 denotes a third drive circuit. The circuit shown in FIG. 6 is basically the same as the circuit shown in FIG. 1 except that the input changeover circuit is not provided and the configuration of the power control circuit is different.

In FIG. 6, a power control circuit 42 includes a MOSFET 2, a diode 3, a choke coil 4, a capacitor 5, resistors 6, 7 and 12, a third drive circuit 24, and a PWM control circuit 22. In the discharge lamp lighting apparatus having the circuit configuration shown in FIG. 6, the MOSFET 2 is disposed on a low side of the power control circuit 42. The low side means a ground side in the power control circuit 42 including an input voltage side to which a voltage is input from outside and ground side. In accordance with the present invention, the MOSFET 2 serving as the switching transistor is provided on the ground side. In the example shown in FIG. 6, the MOSFET 2 is grounded at its source terminal and its drain terminal is connected to the diode 3 and the coil 4. In the example shown in FIG. 6, the diode 3 is provided for stabilization. However, the power control circuit 42 may be formed without the diode 3. For stabilization, it is preferable to provide the diode 3.

In the conventional discharge lamp lighting apparatus including a MOSFET provided on the high side (input voltage side), a transformer is needed to convey a drive signal to between the gate and the source. Since it is necessary that the transformer is not magnetically saturated to convey the signal by using the transformer, the duty is limited to less than 50%. In the discharge lamp lighting apparatus having the configuration shown in FIG. 6, however, the MOSFET 2 is provided on the low side in the power control circuit 42, and consequently the third drive circuit 24 can be formed without a transformer. And since the signal can be conveyed without using a transformer or in a transformerless configuration, the on-duty of the MOSFET 2 can be made up to 100%. As a result, it becomes possible to make the input voltage, i.e., the voltage at the power supply input terminal 1 remarkably lower than those in the conventional apparatus.

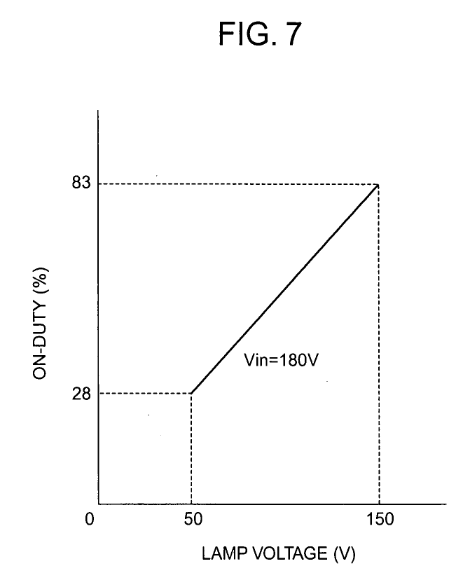

FIG. 7 shows a relation between the on-duty and the lamp voltage of the MOSFET 2 when the input voltage Vin of the power control circuit in the discharge lamp lighting apparatus shown in FIG. 6 is 180 V. When the lamp voltage is 150 V, the on-duty is 83% (150 V/180 V). When the lamp voltage is 50 V, the on-duty is 28% (50 V/180 V). The on-duty has increased to twice as compared with the conventional discharge lamp lighting apparatus shown in FIG. 3A. Accordingly, the drain current of the MOSFET decreases and the loss decreases. Thus, it is possible to provide a discharge lamp lighting apparatus that is high in efficiency and less in unnecessary radiation.

As heretofore described, it is possible to provide a discharge lamp lighting apparatus that is high in efficiency and less in unnecessary radiation even when the lamp voltage is low, by providing means to switch the input voltage according to the lamp voltage or the voltage corresponding thereto. Furthermore, it is possible to increase the on-duty of the switching transistor in the power control circuit and decrease the switching current when the lamp voltage is low, by providing the MOSFET on the low side of the power control circuit. Even if the input voltage of the power control circuit is lowered remarkably as compared with the conventional apparatus, therefore, the efficiency at the time when the lamp voltage is low can be raised and it is possible to provide a discharge lamp lighting apparatus that is less in unnecessary radiation. Therefore, the discharge lamp lighting apparatus according to the present invention can light a large-power discharge lamp at high efficiency.

According to the present invention, it is possible to provide a power saving discharge lamp lighting apparatus.

In the above, the discharge lamp lighting apparatus according to the present invention has been described in detail. However, the present invention is not restricted to this, but various improvements and changes can be made without departing from the spirit of the present invention.

For example, in the discharge lamp lighting apparatus having the configuration shown in FIG. 1, the input voltage of the power control circuit is changed over by switching two power supply input terminals of the input voltage changeover circuit. Alternatively, it is also possible to provide three or more power supply input terminals and change over the input voltage of the power control circuit in multi-steps by changing over the input voltage of the power control circuit to a power supply input terminal having a lower input voltage as the lamp voltage of the discharge lamp falls. Alternatively, continuous changeover may be conducted to lower the input voltage of the power control circuit as the lamp voltage of the discharge lamp falls.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A discharge lamp lighting apparatus for lighting a discharge lamp, the discharge lamp lighting apparatus comprising:
a power control circuit for detecting a lamp voltage and a lamp current of the discharge lamp and controlling a lamp power; and
an input voltage changeover circuit for changing over an input voltage to be input to the power control circuit on the basis of the lamp voltage or a voltage corresponding to the lamp voltage.

2. The discharge lamp lighting apparatus according to claim 1, wherein the input voltage changeover circuit lowers the input voltage as the lamp voltage or the voltage corresponding to the lamp voltage becomes lower.

3. The discharge lamp lighting apparatus according to claim 2, wherein
the input voltage changeover circuit comprises a first input terminal and a second input terminal to which a voltage lower than that of the first input terminal is applied, and
if the lamp voltage or the voltage corresponding to the lamp voltage is lower than a preset threshold, the input voltage changeover circuit changes the first input terminal over to the second input terminal.

4. A discharge lamp lighting apparatus for lighting a discharge lamp, the discharge lamp lighting apparatus comprising:
a power control circuit for detecting a lamp voltage and a lamp current of the discharge lamp and controlling a lamp power,
wherein the power control circuit comprises an input voltage side to which a voltage is input and a ground side, and
a switching transistor is provided on the ground side.

5. The discharge lamp lighting apparatus according to claim 4, wherein
the switching transistor is a MOSFET, and
a source terminal of the MOSFET is grounded.

6. A discharge lamp lighting comprising:
a discharge lamp;
a power control circuit for detecting a lamp voltage and a lamp current of the discharge lamp and controlling a lamp power; and
an input voltage changeover circuit for changing over an input voltage to be input to the power control circuit on the basis of the lamp voltage or a voltage corresponding to the lamp voltage.
